(19) United States
(12) Patent Application Publication
(10) Pub. No.: US 2025/0229549 A1
(43) Pub. Date: Jul. 17, 2025

(54) SHEET DRYING APPARATUS AND IMAGE FORMING SYSTEM PROVIDED THEREWITH

(71) Applicant: KYOCERA Document Solutions Inc., Osaka (JP)

(72) Inventors: Hiroyuki UEDA, Osaka (JP); Mitsuhiro GODA, Osaka (JP); Masaki MURASHIMA, Osaka (JP); Minoru TOKONAMI, Osaka (JP)

(73) Assignee: KYOCERA Document Solutions Inc., Osaka (JP)

(21) Appl. No.: 19/015,211

(22) Filed: Jan. 9, 2025

(30) Foreign Application Priority Data
Jan. 17, 2024 (JP) 2024-005587

(51) Int. Cl. B41J 11/00

(52) U.S. Cl. CPC B41J 11/00222; B41J 11/00216

(57) ABSTRACT

A sheet drying apparatus includes a conveyance portion and a drying portion. The conveyance portion conveys a sheet on which an image is formed with ink containing moisture. The drying portion is arranged opposite the conveyance portion and heats and dries the sheet. The drying portion includes a heating unit having a plurality of infrared heaters extending in the width direction horizontally orthogonal to the conveyance direction of the sheet and arranged side by side along the conveyance direction and a plurality of reflectors that surround the infrared heaters from a direction opposite to the conveyance portion, and a hot air fan arranged opposite the conveyance portion across the heating unit and blowing toward the conveyance portion hot air heated as a result of air passing through the interval between the reflectors. As many reflectors as the infrared heaters are arranged such that each reflector surrounds one infrared heater individually.

### INCORPORATION BY REFERENCE

This application is based on and claims the benefit of priority from Japanese Patent Application No. 2024-005587 filed on Jan. 17, 2024, the contents of which are hereby incorporated by reference.

### BACKGROUND

The present disclosure relates to a sheet drying apparatus that dries sheets on which images have been printed in an inkjet recording apparatus or the like, and to an image forming system provided with such a sheet drying apparatus.

As recording apparatuses such as facsimile machines, copiers, and printers, inkjet recording apparatuses, which form images by ejecting ink onto a sheet, are widely used. Sheet drying apparatuses are known for heating and drying sheets (paper) on which ink has been adhered by inkjet recording apparatuses.

### SUMMARY

According to one aspect of the present disclosure, a sheet drying apparatus includes a conveyance portion and a drying portion. The conveyance portion conveys a sheet on which an image is formed with ink containing moisture. The drying portion is arranged opposite the conveyance portion and heats and dries the sheet. The drying portion includes a heating unit and a hot air fan. The heating unit includes a plurality of infrared heaters that extend in the width direction horizontally orthogonal to the conveyance direction of the sheet and that are arranged side by side along the conveyance direction and a plurality of reflectors that surround the infrared heaters from a direction opposite to the conveyance portion. The hot air fan is arranged opposite the conveyance portion across the heating unit, and blows toward the conveyance portion hot air heated as a result of air passing through the interval between the reflectors. The plurality of reflectors includes as many reflectors as there are infrared heaters such that each reflector surrounds one infrared heater individually.

### BRIEF DESCRIPTION OF THE DRAWINGS

FIG. 1 is a schematic diagram showing the internal construction of an image forming system including a sheet drying apparatus of the present disclosure.

FIG. 2 is a side sectional view around a drying portion in a sheet drying apparatus according to one embodiment of the present disclosure.

FIG. 3 is an enlarged view of the drying portion in FIG. 2.

FIG. 4 is a schematic diagram of a heating unit and a hot air fan used in a sheet drying apparatus according to a first embodiment of the present disclosure.

FIG. 5 is a wind velocity distribution chart as obtained below the heating unit in a case where the heating unit shown in FIG. 4 is used.

FIG. 6 is a schematic diagram of, as a comparative example, a heating unit having three heaters surrounded by one reflector along with the hot air fan.

FIG. 7 is a wind velocity distribution chart as obtained below the heating unit in a case where the heating unit shown in FIG. 6, as a comparative example, is used.

FIG. 8 is a schematic diagram of a heating unit and a hot air fan used in a sheet drying apparatus according to a second embodiment of the present disclosure.

FIG. 9 is a block diagram showing one example of control paths used in the sheet drying apparatus of the second embodiment.

FIG. 10 is a schematic diagram of a heating unit and a hot air fan used in a sheet drying apparatus according to a third embodiment of the present disclosure.

FIG. 11 is a side sectional view of a heating unit used in a sheet drying apparatus according to a fourth embodiment of the present disclosure, as cut along the sheet width direction.

FIG. 12 is an enlarged view of one end, in the width direction, of the heating unit in FIG. 11.

FIG. 13 is a sectional perspective view of the heating unit used in the sheet drying apparatus according to the fourth embodiment, as cut along the sheet width direction.

FIG. 14 is an enlarged view of the other end, in the width direction, of the heating unit in FIG. 13.

### DETAILED DESCRIPTION

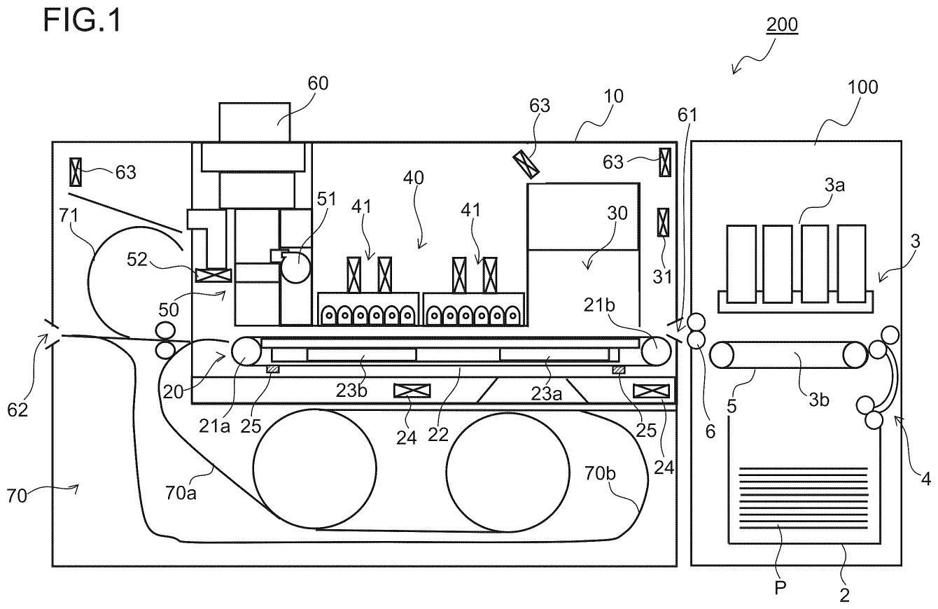

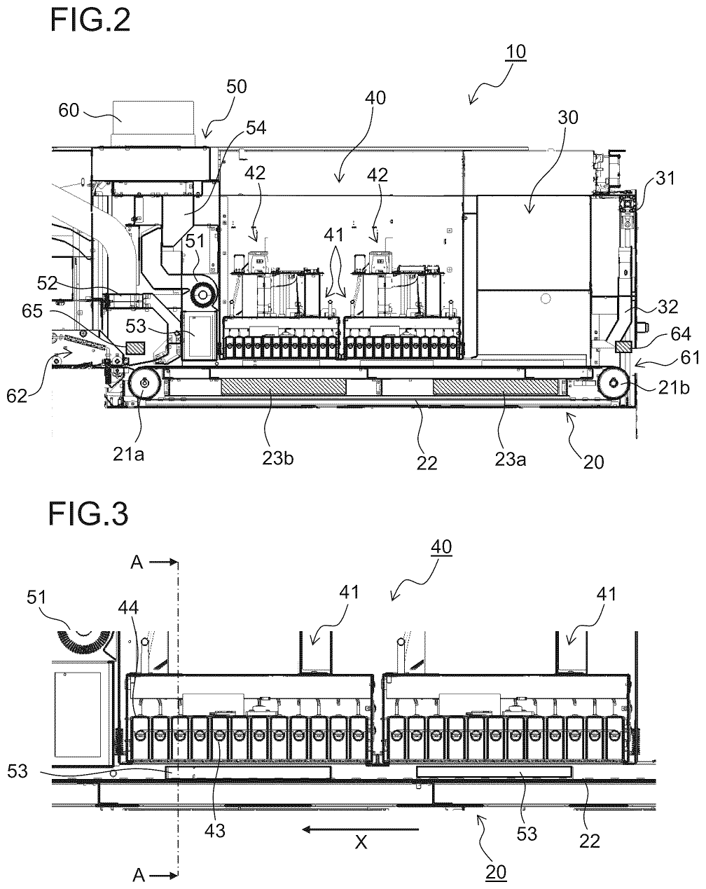

1. Construction of an Image Forming System Including a Sheet Drying Apparatus: An embodiment of the present disclosure will be described below with reference to the accompanying drawings. FIG. 1 is a schematic diagram showing the internal construction of an image forming system 200 including a sheet drying apparatus 10 of the present disclosure. FIG. 2 is a side sectional view around a drying portion 40 in the sheet drying apparatus 10 according to one embodiment of the present disclosure. The image forming system 200 configured with an image forming apparatus 100 and the sheet drying apparatus 10 will be described with reference to FIGS. 1 and 2.

The image forming apparatus 100 is an inkjet recording printer and includes a sheet storage portion 2 arranged in a bottom part of the image forming apparatus 100, an image forming portion 3 arranged above the sheet storage portion 2, and a sheet feed portion 4 that feeds a sheet P stored in the sheet storage portion 2 to the image forming portion 3.

The image forming portion 3 is configured with a recording portion 3a having a plurality of recording heads and a print conveyance portion 3b arranged opposite the recording portion 3a. The print conveyance portion 3b includes an endless print conveyance belt 5 stretched around a plurality of rollers including a driving roller. The sheet P conveyed by the sheet feed portion 4 is conveyed below the recording portion 3a by being held under suction on the print conveyance belt 5 by a sheet suction portion (not shown) arranged inward of the print conveyance belt 5. The sheet P having a predetermined image recorded to it by the image forming portion 3 is discharged through a pair of discharge rollers 6 and is conveyed into the sheet drying apparatus 10.

The sheet drying apparatus 10 is arranged adjacent to the image forming apparatus 100 and dries the ink on the sheet P discharged from the image forming apparatus 100. The sheet drying apparatus 10 includes a first conveyance portion 20, a preliminary drying portion 30, a drying portion 40, a suction fan unit 50, and a second conveyance portion 70.

The first conveyance portion 20 includes a driving roller 21a, a driven roller 21b, and a conveyance belt 22. The conveyance belt 22 is stretched around the driving roller 21a arranged on the downstream side and the driven roller 21b arranged on the upstream side with respect to the conveyance direction of the sheet P (right to left direction in FIG. 1; hereinafter, referred to simply as the conveyance direction).

Inward of the conveyance belt 22 is arranged sheet suction portions 23a and 23b. In the conveyance belt 22, many suction holes (not shown) are formed through which to pass suction air for sucking the sheet P onto the conveyance belt 22 by negative pressure suction by the sheet suction portions 23a and 23b.

Belt cooling fans 24 are arranged at two places below the conveyance belt 22. A belt temperature sensor 25 is arranged adjacent to a bottom face of the conveyance belt 22. The belt cooling fan 24 blows cooling air to the conveyance belt 22 when the sensed temperature of the belt temperature sensor 25 reaches or exceeds a predetermined temperature.

The preliminary drying portion 30 is arranged closely downstream of a sheet introduction port 61 with respect to the conveyance direction and preliminarily dries the ink on the sheet P conveyed in through the sheet introduction port 61. The preliminary drying portion 30 includes a sheet blowing fan 31 and a sheet blowing duct 32 for blowing air from above the sheet P.

The drying portion 40 is arranged adjacently downstream of the preliminary drying portion 30 with respect to the conveyance direction and dries the ink on the sheet P having passed through the preliminary drying portion 30. The drying portion 40 includes two heating units 41 arranged on a top surface of the conveyance belt 22 so as to face each other.

The suction fan unit 50 sucks in the water vapor emanating from the sheet P passing through the drying portion 40. The suction fan unit 50 includes a suction fan 51 that sucks in air containing water vapor inside the drying portion 40 and a separation fan 52 that blows separation air for separating the sheet P from the conveyance belt 22. The suction fan unit 50 communicates with a space between the conveyance belt 22 and the heating unit 41 via a first duct 53 and communicates with an exhausting port 60 formed in a top part of the sheet drying apparatus 10 via a second duct 54.

A plurality of ambient air intake fans 63 for taking in ambient air into the sheet drying apparatus 10 are arranged at appropriate places in the sheet drying apparatus 10. In an upstream and a downstream part of the first conveyance portion 20 are arranged sheet detection sensors 64 and 65. The sheet detection sensors 64 and 65 detect the sheet P having passed through the sheet introduction port 61 and the sheet discharge port 62.

As, by being driven to rotate by the driving roller 21a, the conveyance belt 22 rotates in the counterclockwise direction, the sheet P conveyed in through the sheet introduction port 61 passes through the preliminary drying portion 30 and then through the drying portion 40 to be discharged through the sheet discharge port 62 out of the sheet drying apparatus 10 or conveyed into the second conveyance portion 70.

The second conveyance portion 70 is arranged below the drying portion 40 and the preliminary drying portion 30 across the first conveyance portion 20. The second conveyance portion 70 includes a reversing conveyance passage 70a, for reversing top side down the sheet P on which the ink has been dried, and a duplex conveyance passage 70b, for returning, when duplex printing is performed on the sheet P, the sheet P reversed top side down to the image forming apparatus 100.

Downstream (left side in FIG. 1) of the suction fan unit 50 with respect to the conveyance direction is provided a retraction path 71 in the shape of an arc. The retraction path 71 is where a sheet P (waste sheet) that has become useless due to a printing defect or the like in the image forming apparatus 100 is retracted and stored.

2. Construction of the Sheet Drying Apparatus: FIG. 3 is an enlarged view of the drying portion 40 in FIG. 2. The drying portion 40 includes a heating unit 41 and a hot air fan 42 (see FIG. 2). Two heating units 41 are arranged along the conveyance direction (arrow-X direction). The heating unit 41 include a heater 43 and a reflector 44.

The heater 43 is in the shape of a bar extending in the sheet width direction (the direction orthogonal to the plane in FIG. 3; hereinafter, referred to simply as the width direction) horizontally orthogonal to the conveyance direction. In the heating unit 41, a plurality (12 in FIG. 3) of heaters 43 are arranged side by side along the conveyance direction. In this embodiment, an infrared heater is used as the heater 43.

The reflector 44 is a reflector plate U-shaped as seen in a side view arranged so as to surround the heater 43 from above. The infrared rays emitted from the heater 43 are reflected downward by the inner surface of the reflector 44 and are shone onto the sheet P carried and conveyed on the conveyance belt 22. Thus, the moisture in the ink on the sheet P evaporates and the ink dries; thus, the ink is fixed to the sheet P.

The hot air fan 42 is arranged above the heating unit 41. More specifically, the hot air fan 42 is arranged so as to blow air from above toward the reflectors 44. The air blown from the hot air fan 42 onto the reflectors 44 is heated as it passes through the gaps between the reflectors 44 become hot air to flow into the gap (drying space) between the heating unit 41 and the conveyance belt 22.

If steam or water vapor is present in the gap between the heating unit 41 and the conveyance belt 22, the infrared rays emitted from the heater 43 and reflected from the reflector 44 are absorbed by the steam or water vapor and this impairs their ability to dry the ink on the sheet P. Thus, by operating the hot air fan 42 to blow hot air into the gap between the heating unit 41 and the conveyance belt 22 and scattering and removing the steam or water vapor emanating from the sheet P, it is possible to maintain the drying properties of the ink under infrared rays.

Between the drying portion 40 and the suction fan unit 50, a first duct 53 is provided for sucking the steam or water vapor emanating from the sheet P together with air. The first duct 53 extends from the gap between the heating unit 41 and the conveyance belt 22 to the suction fan 51 in the suction fan unit 50.

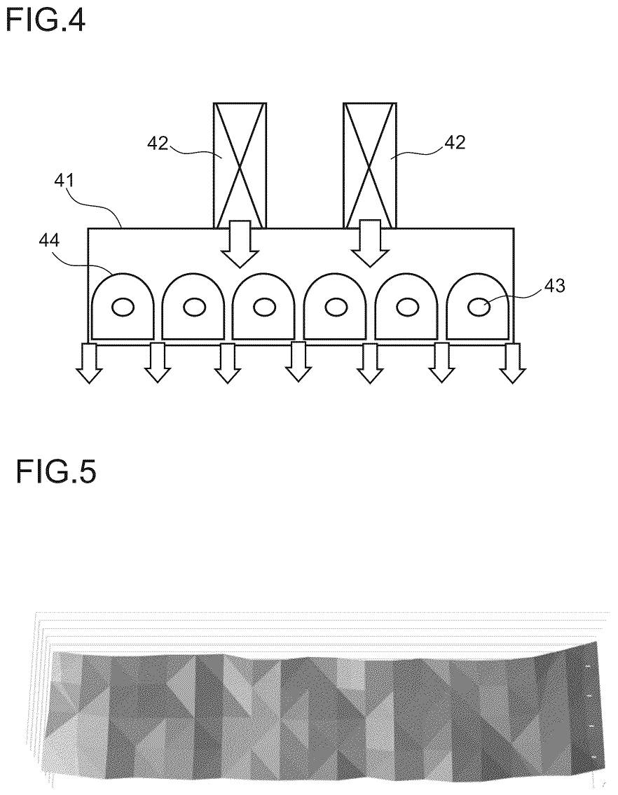

3. Construction of the Heating Unit and the Hot Air Fan: FIG. 4 is a schematic diagram of a heating unit 41 and a hot air fan 42 used in a sheet drying apparatus 10 according to the first embodiment of the present disclosure. FIG. 4, and also in FIGS. 5, 8, and 9, which will be referred to later, deals with an example in which six heaters 43 are arranged in the heating unit 41. The hollow arrows in the figures indicate the flow of air and the size of the hollow arrows indicate the wind velocity (volume).

In the heating unit 41 used in the sheet drying apparatus 10 according to this embodiment, as shown in FIG. 4, one heater 43 is surrounded by one reflector 44. The air blown from the hot air fan 42 onto the reflector 44 passes through the gaps between the reflectors 44 and flows into the gap (drying space) between the heating unit 41 and the conveyance belt 22.

FIG. 5 is a wind velocity distribution chart as obtained below the heating unit 41 in a case where the heating unit 41 shown in FIG. 4 is used. The wind velocity distribution chart is obtained by measuring the wind velocity across the conveyance surface below the heating unit 41 with an anemometer while changing its position and connecting the obtained measured values with a line.

As shown in FIG. 4, surrounding one heater 43 with one reflector 44 results in larger gaps between the reflectors 44 through which the air blown from the hot air fan 42 passes. It hence results in smaller intervals between adjacent gaps. Thus, the hot air can be blown uniformly through the gaps between the reflectors 44 into the drying space. This achieves, as shown in FIG. 5, smaller variation of the wind velocity (volume) in the drying space.

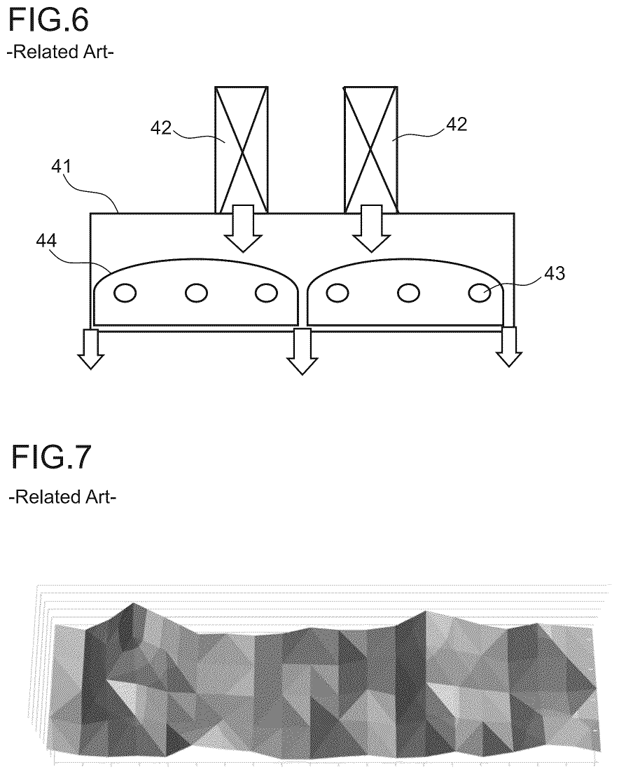

FIG. 6 is a schematic diagram of, as a comparative example, a heating unit 41 having three heaters 43 surrounded by one reflector 44 along with the hot air fan 42. FIG. 7 is a wind velocity distribution chart as obtained below the heating unit 41 in a case where the heating unit 41 shown in FIG. 6, as a comparative example, is used.

As shown in FIG. 6, surrounding a plurality (here, three) of heaters 43 with one reflector 44 results in a larger size of the reflector 44 and hence smaller number of gaps between the reflectors 44. It thus results in larger intervals between adjacent gaps increases. This makes uneven the hot air flowing through the gaps between the reflectors 44 into the drying space.

A result is, as shown in FIG. 7, larger variation of the wind velocity (volume) in the gap between the heating unit 41 and the conveyance belt 22. Specifically, the wind velocity is high in the gaps between the reflector 44 and is low in a middle part of the reflector 44. This makes it difficult to disperse the water vapor and steam at the center of the drying space and leads to poorer drying properties of the ink.

The above observation reveals that, with the construction according to this embodiment in which one heater 43 is surrounded by one reflector 44, hot air can be passed uniformly through the drying space and the water vapor and steam present in the drying space can be efficiently removed to maintain the drying performance of the heater 43 with the ink.

With the construction according to this embodiment, the sheet P conveyed on the conveyance belt 22 is heated with the infrared rays emitted from the heater 43 and reflected by the reflector 44 and with the hot air blown through the gaps between the reflectors 44. It is thus possible to efficiently dry the ink on the sheet P.

The heater 43 that radiates infrared rays and the reflector 44 are arranged in one heating unit 41 and the hot air fan 42 is attached to the heating unit 41, so the heating unit 41 can have a compact construction. In particular, the hot air fan 42 is arranged directly above the reflector 44, so the heating unit 41 can be made small in the conveyance direction and in the width direction and this helps achieve space-saving in the drying portion 40.

The air blown out from the hot air fan 42 strikes the reflector 44 and takes heat from the reflector 44 when passing through the gaps between the reflectors 44. This eliminates the need for a heater dedicated to heating the air from the hot air fan 42 and helps prevent the reflector 44 from overheating, contributing to higher safety.

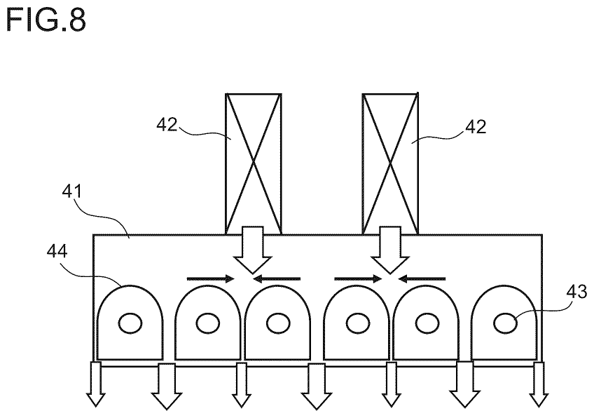

FIG. 8 is a schematic diagram of a heating unit 41 and a hot air fan 42 used in a sheet drying apparatus 10 according to a second embodiment of the present disclosure. In the heating unit 41 used in the sheet drying apparatus 10 of this embodiment, the intervals between the heaters 43 and the reflectors 44 can be individually adjusted.

In the example shown in FIG. 8, of the six sets of heaters 43 and reflectors 44, the second and third sets of heaters 43 and reflectors 44 from each end are moved closer to each other. As a result, larger and smaller intervals alternate between adjacent reflectors 44. The wind velocity (volume) of the hot air is high where the interval between the reflectors 44 is larger and the wind velocity (volume) of the hot air is low where the interval is smaller.

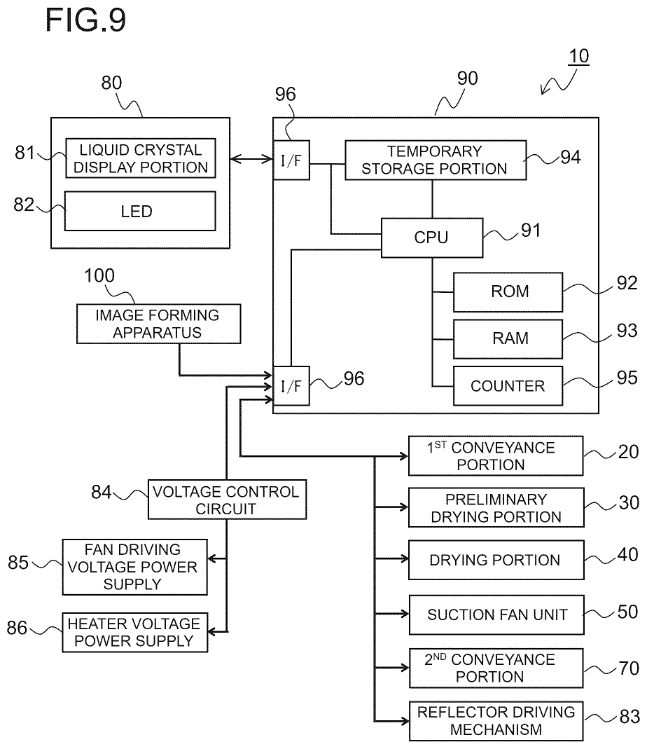

FIG. 9 is a block diagram showing one example of control paths used in the sheet drying apparatus 10 of the second embodiment. For simplicity's sake, the following description will focus on those control paths used in the sheet drying apparatus 10 that are necessary for implementing the present disclosure.

A control portion 90 at least includes a CPU (central processing unit) 91 as a central arithmetic processor, a ROM (read-only memory) 92 as a read-only storage portion, a RAM (random-access memory) 93 as a readable and rewritable storage portion, a temporary storage portion 94 that temporarily stores data required for controlling different parts of the sheet drying apparatus 10, and a plurality of (here, two) I/Fs (interfaces) 96 that transmit control signals to different blocks in the sheet drying apparatus 10 and receive input signals from an operation portion 80.

The ROM 92 stores a control program for the sheet drying apparatus 10 as well as data that are not changed during the use of the sheet drying apparatus 10, such as values necessary for control. The RAM 93 stores necessary data generated in controlling the sheet drying apparatus 10, data temporarily required in controlling the sheet drying apparatus 10, and the like. The RAM 93 (or the ROM 92) also stores, for use in controlling the position of the reflector 44, the relationship between the print ratio of the image formed on the sheet P and the arrangement of the reflector 44. The counter 95 counts the cumulative number of sheets P that have been conveyed.

The control portion 90 transmits control signals from the CPU 91 via the I/Fs 96 to different parts and blocks in the sheet drying apparatus 10. From those parts and blocks, signals indicating their states and input signals are transmitted via the I/Fs 96 to the CPU 91. Examples of the parts and blocks controlled by the control portion 90 include the first conveyance portion 20, the preliminary drying portion 30, the drying portion 40, the suction fan unit 50, the second conveyance portion 70, the operation portion 80, and the reflector driving mechanism 83, and the like.

The print ratio data for the sheet P required in position control for the reflector 44 is input from the image forming apparatus 100 via the I/F 96. The input print ratio data is transmitted to the temporary storage portion 94.

A voltage control circuit 84 is connected to a fan driving voltage power supply 85 and to a heater voltage power supply 86 and, according to output signals from the control portion 90, operates these power supplies. According to control signals from the voltage control circuit 84, the fan driving voltage power supply 85 applies a predetermined voltage to the hot air fan 42 in the heating unit 41 and the heater voltage power supply 86 applies a predetermined voltage to the heater 43 in the heating unit 41.

The operation portion 80 includes a liquid crystal display portion 81 and LEDs 82 that indicate various states. A user operates a stop/clear button on the operation portion 80 to stop the drying of the sheet P and operates a reset button on it to bring various settings for the sheet drying apparatus 10 to default ones. The liquid crystal display portion 81 indicates the status of the sheet drying apparatus 10 and displays the progress of the drying of the sheet P and the number of sheets P that have been introduced. Various settings for the sheet drying apparatus 10 may be made via an input portion 101 on the image forming apparatus 100.

The reflector driving mechanism 83 individually moves the reflectors 44 in the heating units 41 in the conveyance direction. The reflector driving mechanism 83 is composed of, for example, a motor and a rack-and-pinion mechanism.

In this embodiment, based on the print ratio (the ratio of the area where ink is adhered to the surface area) for the sheet P transmitted from the image forming apparatus 100, the intervals between the reflectors 44 are automatically adjusted. For example, when the print ratio of the sheet P conveyed into the sheet drying apparatus 10 is high, the amount of ink adhered to the sheet P is large, so it is necessary to increase the heating efficiency of the heating unit 41 for the sheet P to enhance the drying performance in the drying portion 40. To achieve that, the control portion 90 adjusts the intervals between the reflectors 44 using the reflector driving mechanisms 83 based on the print ratio data transmitted from the image forming apparatus 100.

Specifically, if the print ratio of the sheet P is high, when the sheet P is sufficiently heated by the heating unit 41, that is, when an upstream part of the sheet P in the conveyance direction passes through the drying portion 40, it gives off much water vapor. In this case, to enhance the heating efficiency for the sheet P one possible way is to increase the intervals between the three reflectors 44 upstream in the conveyance direction among the six reflectors 44 in the heating unit 41 and thereby increase the volume of hot air blown toward the upstream part of the sheet P in the conveyance direction.

Or, if it is desired to promptly disperse the water vapor that has emanated from the sheet P, one possible way is to reduce the intervals between the three reflectors 44 upstream in the conveyance direction and thereby increase the velocity of hot air blown toward the upstream part of the sheet P in the conveyance direction. The intervals between the reflectors 44 can be changed freely depending on the amount of ink on the sheet P, the amount of emanating water vapor, and the like.

A configuration where, as in this embodiment, the intervals between the reflectors 44 are automatically adjustable based on the print ratio of the sheet P permits the volume and velocity of hot air flowing through the drying space to be adjusted to be suitable for the amount of ink adhered and the emanating water vapor as actually observed. It is thus possible to enhance the efficiency of heating by the heating unit 41 and the efficiency of dispersing water vapor to achieve more uniform drying properties of the ink.

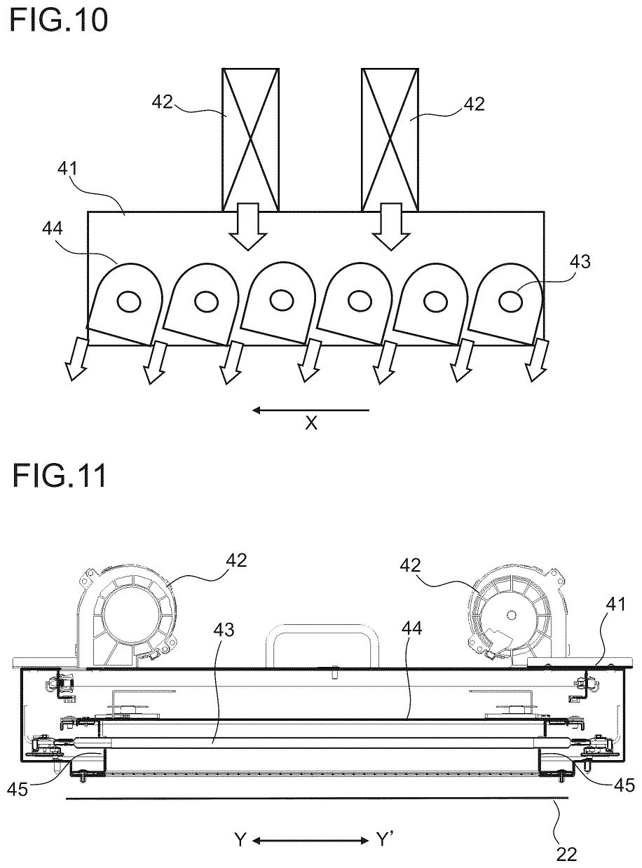

FIG. 10 is a schematic diagram of a heating unit 41 and a hot air fan 42 used in a sheet drying apparatus 10 according to a third embodiment of the present disclosure. In the heating unit 41 used in the sheet drying apparatus 10 of this embodiment, the tilts of the reflectors 44 can be individually adjusted. While the control paths used in the sheet drying apparatus 10 are similar to those in the second embodiment shown in FIG. 9, the reflector driving mechanism 83 varies the tilts of the reflectors 44.

In the example shown in FIG. 10, six reflectors 44 are all tilted so that their lower end parts point downstream (left side in FIG. 10) in the conveyance direction. As shown in FIG. 10, tilting the lower end parts of the reflectors 44 downstream in the conveyance direction allows the hot air having passed through the intervals between the reflectors 44 to flow through the drying space in one direction (from upstream to downstream in the conveyance direction).

Also in this embodiment, based on the print ratio for the sheet P transmitted from the image forming apparatus 100, the tilts of the reflectors 44 are automatically adjusted. For example, when the print ratio of the sheet P conveyed into the sheet drying apparatus 10 is high, the amount of ink adhered to the sheet P is large, so the amount of water vapor emanating from the sheet P is also large. To cope with that, the control portion 90 adjusts the tilts of the reflectors 44 using the reflector driving mechanisms 83 based on the print ratio data transmitted from the image forming apparatus 100.

Specifically, if the print ratio of the sheet P is high, when the sheet P passes through the drying portion 40, it gives off much water vapor. In this case, all the six reflectors 44 in the heating unit 41 are tilted so that their lower end parts point downstream in the conveyance direction to pass the hot air blown toward the sheet P in one direction (downstream in the conveyance direction). It is thus possible to disperse the water vapor and steam present in the drying space in one direction (downstream in the conveyance direction) and enhance the dispersion efficiency of the water vapor and steam.

A configuration where, as in this embodiment, the tilts of the reflectors 44 are automatically adjustable based on the print ratio of the sheet P permits the direction of the hot air flowing through the drying space to be adjusted to be suitable for the amount of water vapor emanated as actually observed. It is thus possible to achieve more uniform drying properties of the ink.

As shown in FIG. 10, tilting the lower end parts of the reflectors 44 downstream in the conveyance direction prevents hot air from blowing out upstream in the drying space. It is thus possible to prevent the sheet P from floating up due to the hot air blowing toward the leading end of the sheet P.

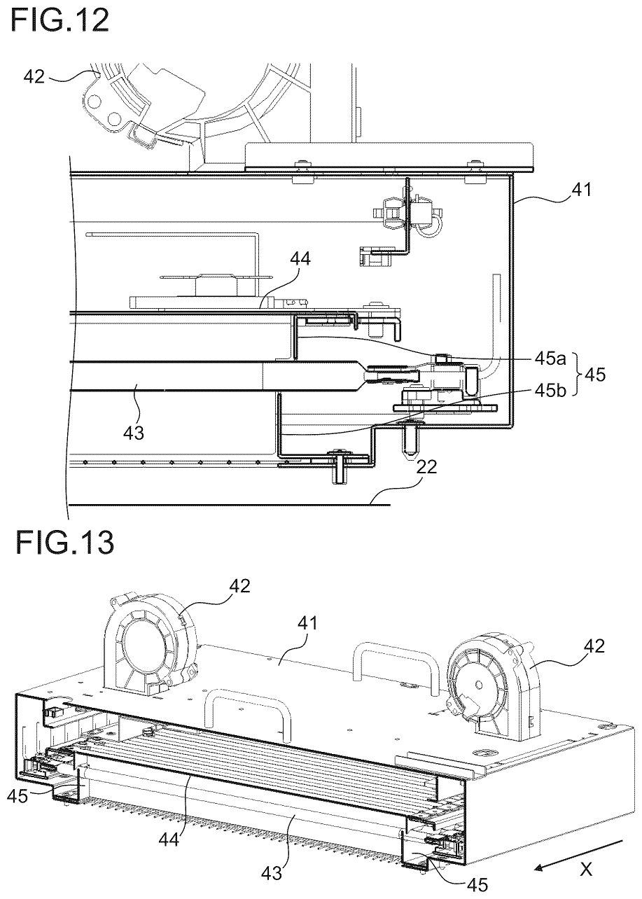

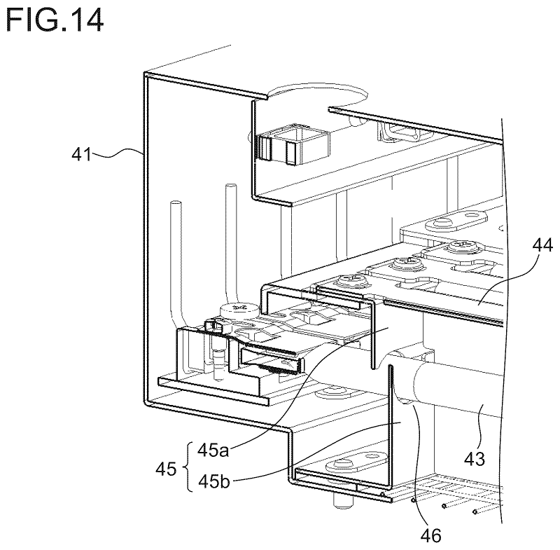

FIG. 11 is a side sectional view of a heating unit 41 used in a sheet drying apparatus 10 according to a fourth embodiment of the present disclosure, as cut along the width direction. FIG. 12 is an enlarged view of one end, in the width direction, (right end in FIG. 11) of the heating unit 41 in FIG. 11. FIG. 13 is a sectional perspective view of the heating unit 41 used in the sheet drying apparatus 10 according to the fourth embodiment, as cut along the width direction. FIG. 14 is an enlarged view of the other end, in the width direction, (left end in FIG. 13) of the heating unit 41 in FIG. 13.

In this embodiment, at the opposite ends, in the longitudinal direction, of the reflector 44 extending along the width direction, auxiliary reflectors 45 are arranged. In other respects, the structure of the heating unit 41 such as the arrangement and construction of the reflectors 44 are similar to those in the first to third embodiments.

As shown in FIG. 11, the auxiliary reflectors 45 are arranged opposite each other in the width direction and their inner surfaces are reflective surfaces. The auxiliary reflector 45 is composed of an upper reflector 45a and a lower reflector 45b. As shown in FIG. 12, an upper end part of the upper reflector 45 overlaps with the reflector 44. A lower end part of the lower reflector 45b faces the conveyance belt 22 across a predetermined interval from it.

As shown in FIG. 13, the auxiliary reflector 45 extends along the conveyance direction so as to overlap with the entire area where the reflectors 44 (the heaters 43) are arranged side by side. As shown in FIG. 14, in the lower reflector 45b, in a part of it facing the upper reflector 45a, a cutout 46 in the shape of an arc is formed to avoid interference with the heater 43.

Arranging the auxiliary reflectors 45 at end parts of the heater 43 helps prevent the hot air flowing into the drying space from above from flowing in the axial direction out of the heater 43. At opposite end parts of the heater 43 in the axial direction, where the irradiation intensity with infrared rays is lower than in a middle part, the infrared rays emitted from the opposite end parts of the heater 43 are reflected inward by the auxiliary reflectors 45, and this helps prevent a drop in the irradiation intensity (radiation heat) with infrared rays at the opposite end parts of the heater 43 and thereby achieve more uniform drying properties of the ink.

The present disclosure can be implemented in any manner other than as in the embodiments described above, and allows for any modifications without departure from the spirit of the present disclosure. For example, in the second and third embodiments described above, the intervals and tilts of the reflectors 44 are automatically adjusted based on the print ratio, but the intervals and tilts of the reflectors 44 may be manually adjusted.

For example, while the embodiments described above deal with a configuration where the sheet drying apparatus 10 is coupled to, as an example of the image forming system 200, an inkjet printer as an image forming apparatus 100, needless to say, the sheet drying apparatus 10 can be used independently without the image forming apparatus 100 coupled to it.

The present disclosure finds applications in sheet drying apparatuses that dry sheets on which images have been printed in inkjet recording apparatuses and the like. Based on the present disclosure, it is possible to provide a sheet drying apparatus that can keep the volume of air in a drying space uniform even when the drying space is enlarged and that can achieve uniform drying properties to prevent uneven drying, and to provide an image forming system provided with such a sheet drying apparatus.

What is claimed is:

1. A sheet drying apparatus comprising:
a conveyance portion that conveys a sheet on which an image is formed with ink containing moisture; and
a drying portion arranged opposite the conveyance portion, the drying portion heating and drying the sheet,
wherein
the drying portion includes
a heating unit having
a plurality of infrared heaters that extends in a width direction horizontally orthogonal to a conveyance direction of the sheet, the plurality of infrared heaters arranged side by side along the conveyance direction; and
a plurality of reflectors that surround the infrared heaters from a direction opposite to the conveyance portion, and
a hot air fan arranged opposite the conveyance portion across the heating unit, the hot air fan blowing toward the conveyance portion hot air heated as a result of air passing through an interval between the reflectors, and
the plurality of reflectors include as many reflectors as the infrared heaters arranged such that each reflector surrounds one infrared heater individually.

2. The sheet drying apparatus according to claim 1, wherein
the interval between the adjacent reflectors is individually adjustable.

3. The sheet drying apparatus according to claim 2, further comprising:
a reflector driving mechanism that moves the reflectors in the conveyance direction; and
a control portion that controls the reflector driving mechanism,
wherein
the control portion adjusts the interval between the adjacent reflectors based on a print ratio of the sheet conveyed by the conveyance portion.

4. The sheet drying apparatus according to claim 3, wherein
if the print ratio of the sheet conveyed by the conveyance portion is equal to or higher than a predetermined value, the control portion increases the interval between the reflectors arranged upstream in the conveyance direction compared with the interval between the reflectors arranged downstream and thereby increases a volume of hot air upstream in the conveyance direction.

5. The sheet drying apparatus according to claim 3, wherein
if the print ratio of the sheet conveyed by the conveyance portion is equal to or higher than a predetermined value, the control portion decreases the interval between the reflectors arranged upstream in the conveyance direction compared with the interval between the reflectors arranged downstream and thereby increases a velocity of hot air blown upstream in the conveyance direction.

6. The sheet drying apparatus according to claim 1, wherein
a tilt of the reflectors in the conveyance direction as seen from the width direction is adjustable to be equal for all the plurality of reflectors.

7. The sheet drying apparatus according to claim 6, further comprising:
a reflector driving mechanism that swings a lower end part of the reflectors in the conveyance direction; and
a control portion that controls the reflector driving mechanism,
wherein
the control portion adjusts the tilt of the reflectors in the conveyance direction based on a print ratio of the sheet conveyed by the conveyance portion.

8. The sheet drying apparatus according to claim 7, wherein
if the print ratio of the sheet conveyed by the conveyance portion is equal to or higher than a predetermined value, the control portion adjusts the tilt of the reflectors in the conveyance direction such that the lower end part of the reflectors tilts downstream in the conveyance direction.

9. The sheet drying apparatus according to claim 1, wherein
at opposite ends of the reflectors in the width direction, a pair of auxiliary reflectors are arranged opposite each other in the width direction.

10. The sheet drying apparatus according to claim 9, wherein
the auxiliary reflectors extend along the conveyance direction so as to overlap with an area where the plurality of reflectors are arranged side by side.

11. An image forming system comprising:
an image forming apparatus that performs image formation on a sheet with ink containing moisture; and
the sheet drying apparatus according to claim 1 that is coupled to the image forming apparatus at a downstream side thereof in the conveyance direction of the sheet, the sheet drying apparatus drying the sheet on which an image is formed by the image forming apparatus.
